(19) United States
(12) Patent Application Publication
(10) Pub. No.: US 2010/0281194 A1
(43) Pub. Date: Nov. 4, 2010

(54) Modular application computing apparatus, system and method

(76) Inventor: Robb Fujioka, Manhattan Beach, CA (US)

Correspondence Address: DRINKER BIDDLE & REATH;ATTN: INTELLECTUAL PROPERTY GROUP, ONE LOGAN SQUARE, SUITE 2000, PHILADELPHIA, PA, 19103-6996, US

(21) Appl. No.: 12/584,275

(22) Filed: Sep. 2, 2009

Related U.S. Application Data
(60) Provisional application No. 61/190,806, filed on Sep. 2, 2008.

(51) Int. Cl. G06F 9/46; G06F 13/12

(52) U.S. Cl. 710/72; 719/328

(57) ABSTRACT

An apparatus, system and method of open platform computing. The present invention may include at least one microprocessor, a computer case that encases the at least one microprocessor, at least one operating system resident on the at least one microprocessor, wherein the at least one operating system includes an open platform for accepting a plurality of applications and hardware not presented as forming a portion of, and absent the plurality of applications not being operable by, the at least one operating system, at least three ports in the computer case, wherein the ports are communicatively electrically connected to the at least one microprocessor, and wherein at least one of the plurality of applications is applied at least one of the ports for presentation by the at least one microprocessor via the at least one operating system.

### CROSS-REFERENCE TO RELATED APPLICATIONS

This application claims priority to U.S. Provisional Application No. 61/190,806, entitled MODULAR APPLICATION COMPUTING APPARATUS, SYSTEM AND METHOD, filed on Sep. 2, 2008 and naming inventor Robb Fujioka, which application is hereby incorporated by reference herein as if set forth in the entirety.

### BACKGROUND OF THE INVENTION

1. Field of the Invention

The present invention relates generally to computers and computing applications and, more particularly, to a modular application computing apparatus, system and method.

2. Description of the Background

At present, typical home and office computing methodologies provide hardware and software in a relatively “one size fits all” mentality. That is, computers at present provide, at different levels of expense, certain hardware and software capable of performing certain functions and providing certain speeds, memory, and the like, for all purchasers at each price level. Thereby, it is inevitable at each price point in the present computer market that a purchaser will pay for hardware and/or software that he or she does not intend to, and in fact will not, make use of. Further, in the event the purchaser wishes to make a change in that which he or she will make use of in a “one size fits all” computer presented for purchase, the purchaser must typically either request such change at the time of purchase of the computing system, or must have sufficient expertise to make the desired modifications him or herself subsequent to purchase, or must be willing to make significant expenditures after purchase to have another make the desired modifications.

Therefore, the need exists for a life style oriented computing solution that provides a cloud computing solution in an open platform format, that is, that provides a computing solution that allows a user to use, and purchase, principally the hardware and only the software that the user will make use of, and that later allows a user to inexpensively and easily add features to the purchased computing solution as those features become desirable to the user.

### SUMMARY OF THE INVENTION

The present invention provides an apparatus, system and method of open platform computing. The present invention may include at least one microprocessor, a computer case that encases the at least one microprocessor, at least one operating system resident on the at least one microprocessor, wherein the at least one operating system includes an open platform for accepting a plurality of applications and hardware not presented as forming a portion of, and absent the plurality of applications, not operable by, the at least one operating system, at least three ports in the computer case, wherein the ports are communicatively electrically connected to the at least one microprocessor, and wherein at least one of the plurality of applications is applied at least one of the ports for presentation by the at least one microprocessor via the at least one operating system.

### BRIEF DESCRIPTION OF THE FIGURES

Understanding of the present invention will be facilitated by consideration of the following detailed description of the preferred embodiments of the present invention taken in conjunction with the accompanying drawing, in which like numeral refers to the like parts:

FIG. 1 illustrates an exemplary embodiment of the present invention;

FIG. 2 illustrates an exemplary embodiment of the present invention; and

FIG. 3 illustrates an exemplary embodiment of the present invention.

Thus, the present invention provides a life style oriented computing solution that provides a cloud computing solution in an open platform format, that is, that provides a computing solution that allows a user to use, and purchase, principally the hardware and only the software that the user will make use of, and that later allows a user to inexpensively and easily add features to the purchased computing solution as those features become desirable to the user.

### DETAILED DESCRIPTION OF THE INVENTION

It is to be understood that the figures and descriptions of the present invention have been simplified to illustrate elements that are relevant for a clear understanding of the present invention, while eliminating, for the purposes of clarity, many other elements found in typical computing apparatuses, systems and methods. Those of ordinary skill in the art will recognize that other elements are desirable and/or required in order to implement the present invention. However, because such elements are well known in the art, and because they do not facilitate a better understanding of the present invention, a discussion of such elements is not provided herein.

The present invention provides a lifestyle oriented computing solution. More specifically, current home and office computing methodologies provide hardware and software in a relatively “one size fits all” mentality. That is, computers at present provide, at different levels of expense, certain hardware and software capable of performing certain functions and providing certain speeds, memory, and the like, for all purchasers at each price level. Thereby, it is inevitable at each price point in the present computer market that a purchaser will pay for hardware and/or software that he or she does not intend to, and in fact will not, make use of. The present invention provides a life style oriented computing solution in that it provides a cloud computing solution in an open platform format, that is, it provides a computing solution that allows a user to use, and purchase, principally the hardware and only the software that the user will make use of. Further, in the event the purchaser makes a change in that which he or she will make use of, the present invention allows for the purchaser to readily and easily modify the initial computing solution to encompass the new need that has arisen.

Thus, in one exemplary embodiment, the present invention may include an open platform computer made up of at least one microprocessor, a computer case that encases the at least one microprocessor, and at least one operating system resident on the at least one microprocessor. The at least one operating system may include an open platform for accepting a plurality of applications not presented as forming a portion of the at least one operating system. There may be any number of ports, such as at least three ports, in the computer case, and the ports may be communicatively electrically connected to the at least one microprocessor. Finally, the at least one of the plurality of applications may be applied at least one of said ports for presentation by the at least one microprocessor via the at least one operating system.

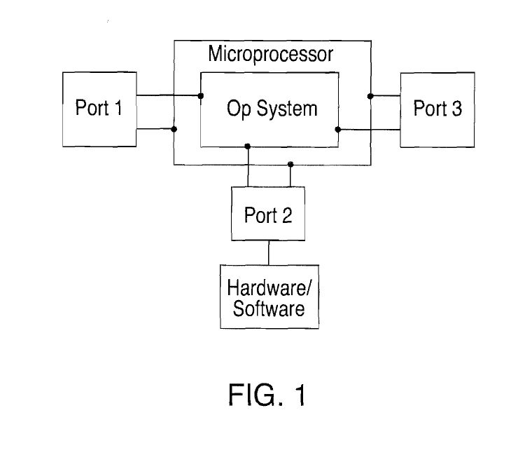

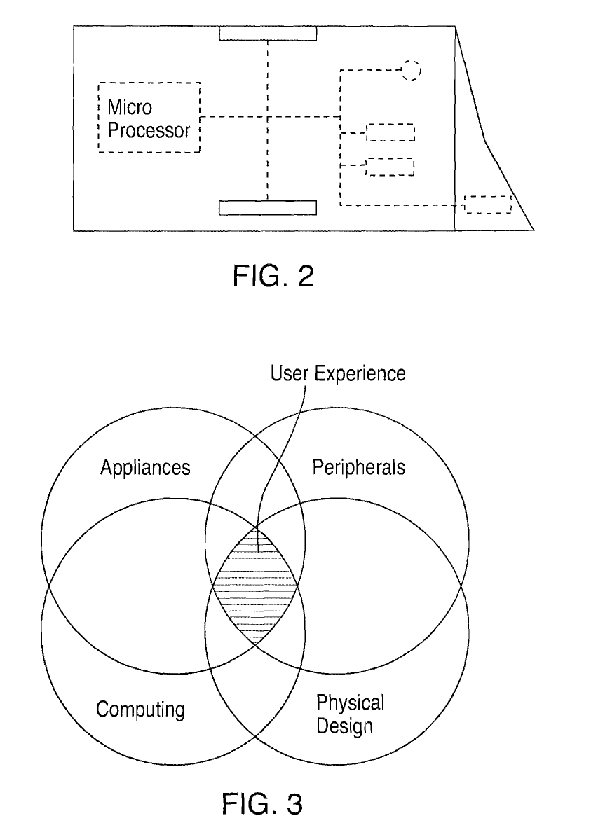

In fact, through the use of the present invention, the purchaser can be provided with solutions other than strictly computing solutions, that is, the user can be provided with replacement technology for other technologies and/or items in and around an office or a household, as will be further explained hereinbelow. More specifically, FIG. 1 illustrates a block diagram of the open platform solution provided by the present invention. FIG. 2 illustrates a schematic embodiment of the hardware provided by the present invention.

With reference to FIGS. 1 and 2, the present invention provides a computing solution capable of driving only that hardware, that software, those appliances, and those peripherals desired to be driven by a user of the instant computing solution. Thereby, the present invention provides a modular computing solution that not only introduces modular revenues for the computing industry, but that additionally provides a computing solution that can be developed uniquely by each user for that user's life style profile. For example, modules may be added for use with the present invention that provide Internet computing, word processing computing, a set top box, a recipe system for use in a kitchen, or an iPod/MP3 player/radio for use by a swimming pool. Such myriad capabilities may be modularly provided, that is, may be separately made available and/or purchased for use with the initially purchased base computing system.

The base computing system preferably provides an open platform for use in the present invention. The base computing system may be, for example, a Linux based machine, and/or may employ open source software and platforming, and/or may thus provide an openware solution. Such an “open format” computer may provide only that desired by the user in a base model computer. Thus, for example, as illustrated in FIG. 2, the computing device of the present invention at the base level may be provided with a plurality of USB, Ethernet, RCA, Optical, and like inputs, into which may be connected any number of appliances, peripherals, software modules, and the like. Such input ports may include, for example, a hardware and/or software port at the top of the unit, such as at the back of the unit top, or in the center of the unit top, and facing upward, ports on the front, sides, back, and even on the stand for the unit, and/or a power port, for example. Any mix of types of such ports, and in any locations, may be provided. Further, an application may, in certain embodiments, entail provision of application software at one port of the present invention, and operation of application specific hardware correspondent to the application software at one or more other ports. Ports may, for the purposes discussed herein, be interchangeable as to what is applied to any given port in a particular application, and may not be interchangeable for the purposes of other application modules. Additionally, the unit may be enabled to operate for periods of time, or permanently, on one or more batteries, rather than a plug-in power supply.

More specifically, in an exemplary embodiment of the present invention, a user may purchase, inexpensively, such as for ninety-nine dollars, a base computing system. Resident on that base computing system may be only limited operating system software, such as Linux based operating system software, such as a thin client or thick client operating system, such as the UrSpin operating system made by Fuhu. The operating system of the present invention may provide, upon implementation and/or purchase of the computer, no, or very limited, application functionality. However, the user may be enabled to add on application hardware/software modules to provide functional computing aspects for execution by the open operating system. For example, in certain embodiments, the base computing system may be provided with a computing screen and may otherwise simply be a black box with a plurality of ports therein and a computing screen. The user may purchase a word processing module, wherein, for a limited expense in addition to the base computing system, the user is provided with word processing software for execution with the operating system, along with a computing mouse and keyboard, and/or, in certain embodiments wherein a screen is not provided, a screen having only a USB male connector to mate with a USB female connector at the lower front of the base unit, for example.

In an additional alternative embodiment, the instant invention may be equipped as a modular photograph computing solution. For example, a user may purchase a module consisting of a variety of peripherals for attaching to cameras, and/or a camera, and further software for communicating with such cameras, and additionally software for downloading and/or processing and/or manipulating photographs. Additionally or alternatively, such a computing solution may allow for, or come with, a photo printer module for plugging in to the instant computing solution.

In an additional alternative embodiment, the instant computing solution may be sold at a low price, such as ninety-nine dollars, as a bundled, dedicated computing solution. For example, such as for office use, the instant invention may be bundled and sold as a conferencing center. For example, the aforementioned operating system may be populated with one or more conferencing solutions, such as networked, audio and/or video conferencing, and/or with certain conferencing software, such as the Skype® conferencing solution. Such a conferencing computing solution may include, for example, an online video camera for use with videoconferencing, a plug and play microphone and/or speaker system, a computing screen, which may be built into the main unit as mentioned hereinabove, and a control pad, either in software or in a hardware keyboard format, or in both formats, for example.

In an additional alternative embodiment, the instant invention may be bundled for use as a digital picture frame. However, needless to say in light of the discussion hereinabove, a digital picture frame provided by the instant invention would be far more powerful from a computing standpoint than conventional digital picture frames. For example, the aforementioned “box” purchased by a user may, in a digital picture frame embodiment, come with a preinstalled digital picture frame operating system, which may include, for example, capabilities for downloading pictures, uploading pictures, interfacing with Internet sites on which are resident pictures, software for manipulating pictures, and the like. Further, such a digital picture frame embodiment may come equipped with a plurality of ports into which can be plugged any of a myriad of storage devices on which are resident pictures, which storage devices may then be read by the digital picture frame operating system. Further, for example, unlike conventional digital picture frames, this exemplary embodiment of the present invention may be capable of offloading pictures from the operating system to external storage devices through the use of the aforementioned ports.

Alternative embodiments may include more specifically software based module applications. For example, an auction based computing solution may be purchased in the present invention, in which only on-line auction-based software is provided for use by the user through the operating system. Further, such auction based software may be an allowance to link to on-line auction sites, or may be an independent software solution that monitors such sites, but in a format unique to the present invention. Such an application based bundle or module may include the aforementioned on-line auction software solution, a mouse, a keyboard, and an Internet access solution, and no additional or wasted software or hardware. Such module software may be provided in any known format for use in the instant invention, such as being loaded via a USB port from, for example, a memory stick or the like.

Additionally, as mentioned hereinabove, the present invention may provide module appliance based solutions. For example, the present invention may be purchased as an email module, wherein the machine is dedicated to receiving and sending emails, and wherein the machine includes a foldable screen of any desired size, and a built-in or external keyboard or mouse. However, unlike the prior art, such an email module may be provided as a programmable or non-programmable power strip, and/or in fact may be designed to appear as a lamp base or the like. In such an embodiment, the user may be able to program the power strip to turn the lamp on or off at a desired interval, or may simply use the power strip as connected to a wall switch to turn the lamp on or off. Further, the lamp may be or include a light indicating email has been received, or in fact the machine may turn on the aforementioned lamp when email has been received. Upon receipt or desire to send email, the user may access the small hidden screen and/or keyboard and mouse to engage with the email program, and, after use, may return the hidden items to the appearance of a lamp base. It will be well understood by those skilled in the art that the aforementioned appliance related example is made only by way of example, and that any number of appliance based applications may be indicated in the present invention.

In a further example of an appliance based application, a user may purchase the instant invention as either a radio bundle, or may purchase a radio module for use with the present invention. Such a radio based application device may include, for example, USB plug-in mini-speakers, interactive radio elements such as volume, treble, and bass controls, a manner of displaying a song being played, a radio station tuned to, and/or an artist, and which may additionally display graphics associated with a song or songs, and software capable of interacting with the operating system to download, upload, and play music from any of a variety of locations and in any of a variety of formats. For example, such an application based radio device may interface with online sites at which a user has stored favorite music, may allow for download from CD's, may include a radio tuner, and/or may include an interface to download from any of a variety of formats, such as from MP3 players or the like. In such an embodiment, a radio appliance may be provided by the present invention, which radio appliance, unlike the prior art, includes a far more powerful operating system along with the ability to download from any of many locations, including, perhaps, from the Internet, and to play music in any location just as would a standard radio appliance.

The aforementioned exemplary embodiments are non-limiting. For example, myriad other possibilities for discrete application modules will become apparent to those skilled in the art in light of the disclosure herein, and particularly in light of the type and location of hardware-accepting ports discussed herein. Such application will include, for example, providing modular applications that provide Internet browsing, email, newspaper(s), telephone, television, alarm clock, and the like.

For the sake of clarity, “applications” as discussed herein are not intended to be, although they may include, merely driver software. For example, the prior art, on occasion, provides a hardware device bundled with driver software, which driver software, when interacted with one or more applications in an operating system in the presence of the hardware that is to make use of the driver software, allows for operation of the hardware by the operating system to occur. However, contrary to the prior art, the present invention provides an operating system that typically does not have an application resident thereon to execute driver software for the hardware of the modules of the present invention. Rather, the present invention provides the necessary hardware, driver software, and the application for interacting with the necessary hardware via the operating system, discretely with each separately obtained bundle.

Due to the module and/or bundled nature of the instant invention, the instant invention provides many advantages over prior art applications. For example, because of the functionality of the instant invention as a dedicated machine dedicated to certain purposes, the instant invention needs only provide sufficient security for the purpose for which the instant invention is being used. For example, for most applications of the present invention, no passwords or other security are necessary, in part because there is little or no information to hack or steal, thereby simplifying use and the speed to which a user can put the instant device to use. Further, the instant invention allows for the addition only of desired modules, or application packs, such as via USB ports. Thereby, through the exposure of numerous interface ports, the instant invention allows for the addition of the aforementioned application packs in the form of applications, such as software applications, peripherals, and even appliances, unlike the prior art which limits and/or endeavors to hide the input ports. Further, the present invention is advantageous in that it provides only what a user needs in order to perform the desired functionality, thereby limiting that with which the user needs to interface, and additionally limiting that which the user needs to learn how to operate. Further, the aforementioned modules and/or application packs may be provided with differing elements based on those elements that may make for an improved user experience. For example, a dedicated email machine may be provided with a bigger screen for ease of viewing, and may be provided with a full size keyboard for ease of typing. Further, as mentioned hereinabove, such an email device user need only learn how to use that screen, that keyboard, and that email program, and need not learn about complex unnecessary software, video drivers, and the like.

Further, it will be appreciated by those skilled in the art that the instant invention may provide for a myriad of marketing and sales opportunities. For example, the openware operating system, such as a Linux based operating system, which may be provided on the present device, may, in all or certain embodiments, or bundles, or certain uses, additionally include a preferred search engine, for which the user may pay a token amount included in or in addition to the low price of the present invention device. Additionally, the present invention may require registration of those bundles, modules, and/or application packs upon purchase by the user, and thus may provide information about the preferences of users, the economics of such users, and the computing usage of such users, for example. Further, because of the open platform solution of the instant invention, any entities may create and/or market modules for use with the instant invention.

Thus, as illustrated in FIG. 3, the present invention provides a new platform. The platform may include, interface with, and provide for, open source software, “open source hardware” (such as incorporation of toy, furniture, and appliance hardware designs, and the like), and/or an open application programming interface (API), to thereby allow, via the provision of minimal initial software, such as a very basic Linux operating system, and very minimal hardware, such as a microprocessor, memory, and various ports, which may include an Internet access port and/or wireless access, an improved user experience at a point of overlap between reinvention of appliances, reinvention of computing peripherals, reinvention of modular computing, and reinvention of incorporating real world design aspects into computing hardware.

More specifically, as used herein “open source hardware” constitutes an availability to any hardware designer to design any type of hardware and/or computing peripherals for interoperation and/or connection with the modular computing system of the present invention. As such, hardware and peripherals include physical aspects of interfaces to the present invention, including, but not limited to, appliances, furniture, electronic devices, and the like. Thereby, for example, home appliances and/or electronic devices may have computing applications applicable thereto.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention.

What is claimed is:

1. An open platform computer, comprising:
at least one microprocessor;
a plurality of external interfaces to said at least one microprocessor, comprising at least three ports, wherein said ports are communicatively electrically connected to the at least one microprocessor; and
at least one operating system resident on the at least one microprocessor, wherein said at least one operating system comprises an open platform for accepting a plurality of applications resident exclusively on a memory device presented at one or more of said ports, wherein each of the plurality of applications is correspondent to at least one independent hardware device, which at least one hardware device is, absent the correspondent one of the plurality of applications, not operable by said at least one operating system.

2. The open platform computer of claim 1, wherein at least one of said plurality of applications comprises a conference center.

3. The open platform computer of claim 1, wherein at least one of said plurality of applications comprises a picture frame.

4. The open platform computer of claim 1, wherein at least one of said plurality of applications comprises an email module.

5. The open platform computer of claim 1, wherein said at least one hardware device comprises an electronic display.

6. The open platform computer of claim 1, wherein said at least one hardware device comprises a modular appliance.

7. The open platform computer of claim 6, wherein said modular appliance comprises a toaster.

8. The open platform computer of claim 6, wherein said modular appliance comprises a lamp.

9. The open platform computer of claim 1, wherein said at least one hardware device comprises a radio display.

10. The open platform computer of claim 1, wherein one of said at least three ports comprises a USB connection.

11. The open platform computer of claim 9, wherein a second and third of said hardware devices comprise accessories for a first of said hardware devices.

12. The open platform computer of claim 1, wherein said at least one operating system comprises Linux.

13. The open platform computer of claim 1, wherein one of said at least three ports comprises a proprietary connector.

14. The open platform computer of claim 1, wherein said plurality of external interfaces accepts a modular connection of open source hardware to said microprocessor.

15. The open platform computer of claim 14, wherein said open source hardware is designed by a hardware designer.

16. The open platform computer of claim 14, wherein said open source hardware includes at least one of appliances, furniture and electronic devices.

17. A computing platform, comprising:
at least one open source software for interacting with at least one modular software, wherein the open source software comprises an open application programming interface; and
at least one open source hardware that interacts with the at least one modular software, wherein at least a portion of the open source hardware comprises at least a functional aesthetic design and a computer peripheral.

18. The computing platform of claim 17, wherein said at least one open source hardware comprises a conference center.

19. The computing platform of claim 17, wherein said at least one open source hardware comprises a picture frame.

20. The computing platform of claim 17, wherein said at least one open source hardware comprises an email module.

21. The computing platform of claim 17, wherein said at least one open source hardware comprises an electronic display.

22. The computing platform of claim 17, wherein said at least one open source hardware device comprises a modular appliance.

23. The computing platform of claim 22, wherein said modular appliance comprises a toaster.

24. The computing platform of claim 22, wherein said modular appliance comprises a lamp.

25. The computing platform of claim 17, wherein said at least one open source hardware comprises a radio display.

26. The computing platform of claim 17, further comprising at least one port to enable electrical coupling between said at least one open source hardware and said at least one modular software.

27. The computing platform of claim 26, wherein said at least one port comprises a proprietary connector.

28. The computing platform of claim 26, wherein said at least one port comprises a USB connection.

29. The computing platform of claim 17, wherein said open source hardware is designed by a hardware designer.

30. The computing platform of claim 17, wherein said open source hardware includes at least one of appliances, furniture and electronic devices.
